(19) United States
(12) Patent Application Publication
(10) Pub. No.: US 2016/0350832 A1
(43) Pub. Date: Dec. 1, 2016

(54) METHOD AND SYSTEM FOR AUTOMATICALLY GENERATING RECOMMENDATIONS FOR A CLIENT SHOPPING LIST

(71) Applicant: AHOLD LICENSING SÀRL, Geneva (CH)

(72) Inventors: Tim FRANKLIN, Volo, IL (US); Robert HIRSCH, Chicago, IL (US); Joseph WATTS, Arlington Heights, IL (US); Andrew KANG, Chicago, IL (US); Dan MCQUILLAN, Mount Prospect, IL (US); Grant ALLOR, Wheaton, IL (US); Olga OPALKO, Buffalo Grove, IL (US); Michael HOGAN, Chicago, IL (US)

(21) Appl. No.: 15/164,966

(22) Filed: May 26, 2016

Related U.S. Application Data
(60) Provisional application No. 62/167,972, filed on May 29, 2015.

(51) Int. Cl. G06Q 30/06

(52) U.S. Cl. CPC G06Q 30/0631; G06Q 30/0633

(57) ABSTRACT

A recommender system for use on a mobile platform or other computing device provides a user with a recommended list of products with default product quantities that are based on prior purchase behavior of the user or customer. This feature relies on analyzing a customer's past purchases and associating a score with each product. The scoring system indicates the statistical likelihood that the customer would want or need to purchase that item on their next order. The customer analysis takes into account, e.g., the number of times a customer has ordered a product, how frequently the product is ordered by the customer, how many days since the respective customers last order and the customers average order size in providing the recommended list of products.

### FIELD OF THE INVENTION

The present invention is directed to a method and system for automatically generating recommendations for a client shopping list. More specifically, the invention is directed to method and system for generating recommendations for a shopping list automatically based on predetermined criteria and prior historical data.

### BACKGROUND OF THE INVENTION

Current online and mobile platform ordering applications are complex for the user and fail to take into account relevant historical data associated with a users purchasing history. Online purchasing websites frequently provide numerous product selections that may confound the user when placing an order. Often a repeat visitor or subscriber to the site will make repeat purchases or purchases that suggest a certain spending profile. The lengthy product selections may not be necessary, or even helpful, for the user shopping experience.

The goal of the disclosed invention is to simplify the process of reordering with the vendor of goods. The vendor wishes to leverage its knowledge of the customer and the customers purchasing characteristics, or behavior, to create as accurate a replenishment shopping list as possible. Using the disclosed invention, the user is able to fill their cart with a few simple clicks of a mouse on a computing device, whether mobile or stationary.

The invention provides smart shopping tools for time-starved customers who desire an easy and efficient ordering process.

### SUMMARY OF THE INVENTION

The novel feature, referred to as “Order Genius”, provides a user with a recommended list of items or products with default item or product quantities that are based on prior purchase behavior of the user or customer. This feature relies on an intermediate computer or the like analyzing a customers past purchases and associating a score with each product. The scoring system indicates the statistical likelihood that the customer would want or need to purchase that item on their next order. The customer analysis takes into account, e.g., the number of times a customer has ordered a product, how frequently the product is ordered by the customer, how many days since the respective customer's last order and the customers average order size in providing the recommended list of items or products to a customer device.

In addition to providing a list of candidate items or products for the list, the invention evaluates how many items or products on average a customer purchases in each of the lowest level categories. The invention applies an algorithm configured to not recommend more items or products per subcategory than the customer normally purchases in an order on average. For example, if the customer buys 1 gallon of 2% milk on average per order, but the customer purchasing history may indicate the customer does not have a preference to a particular brand product. The customer may have 10 previous orders where the customer bought Deans 2% milk, for example, and 9 orders where the customer bought Centrella 2% milk. Both of these products share the subcategory of 2% milk and are purchased frequently. However, because data associated with the respective customer indicate an average order quantity for 2% milk is one, the system will only recommend one of the 2% milk products.

The recommender system evaluates the contents of the customer's current shopping cart to adjust for the amount of remaining budget dollars, to recommend as well as reduce the number of slots available per product category. In the example provided in the preceding paragraph, the customer may order one item or product on average per order in the 2% milk subcategory. The customer has placed one gallon of Dean's 2% milk in his shopping cart before accessing the recommender system. The recommender system will recognize the presence of the milk product in the shopping cart and reduce the average slot count for the 2% milk subcategory by the number of items or products—in this case, one—already placed in the shopping cart. The following algorithm is applied by the recommender system:

(average cart count)—(items in cart)=remaining slots to fill.

In this example, 1−1=0. Therefore, the recommender system will not include any of the 2% milk past purchases in the recommended list. The recommender system will also exclude any items in the shopping cart on the recommended list as a general business rule.

The final output from the recommender system is the most likely set of items or products the customer would purchase based on a historical average quantity per item or product up to the limit of the shopping cart recommender system. The limit may be based, e.g., on the customers historical average order size, and will incorporate a percentage of variance to accommodate product recommendations within proximity of that historical average dollar amount. If the shopping cart already contains a percentage amount, which percentage deviation may be configurable, of the average order size for the customer, the recommended list will contain enough items or products up to the average order size plus an additional amount of money allocated for items or products. The additional amount of money allocated may be configurable by the feature.

The list of items or products may be presented by the recommender system in a single view, ordered by category with a default quantity set for each product in the list. Each item or product displayed includes a checkbox next to the item or product indicating that it is selected or checked. A SELECT ALL checkbox is provided at the top of the listing column as well to enable selecting or deselecting all items in the list. Each product can be selected or unselected individually. A total dollar amount is calculated and displayed to the customer to indicate the total dollar amount associated with the items or products selected in the list. With a single Add to Cart option, all the selected items and the associated quantity indications will be added to the shopping cart.

An embodiment is directed to a computer implemented method for generating a recommended shopping list for a customer. The method including: analyzing, by an intermediate computer, the customer's past purchases; scoring, by the intermediate computer, items purchased by the customer in the past purchases to determine the likelihood that the customer will desire to purchase respective items on their next order; generating, by the intermediate computer, the recommended shopping list based on the scoring of the items; and transmitting from the intermediate computer to a customer device the recommended shopping list.

An embodiment is directed to a computer implemented method for generating a recommended shopping list for a customer. The method includes: analyzing, by an intermediate computer, the customer's past purchases; scoring, by the intermediate computer, products purchased by the customer in the past purchases to determine the likelihood that the customer will desire to purchase respective products on their next order, the scoring using the number of times the customer has previously ordered the product, the frequency of times the customer has previously ordered and the number of days since the customer has last ordered the product to score the product; generating, by the intermediate computer, the recommended shopping list based on the scoring of the products; and transmitting from the intermediate computer to a customer device the recommended shopping list.

An embodiment is directed to a system for generating a recommended shopping list for a customer. The system includes: analyzing, by an intermediate computer, the customer's past purchases; scoring, by the intermediate computer, items purchased by the customer in the past purchases to determine the likelihood that the customer will desire to purchase respective items on their next order; calculating the historical average customer order size in dollars to establish a budget limit; generating, by the intermediate computer, the recommended shopping list based on the scoring of the items and the budget limit; and transmitting from the intermediate computer to a customer device the recommended shopping list.

An embodiment is directed to a system for generating a recommended shopping list for a customer. The system includes: analyzing, by an intermediate computer, the customer's past purchases; scoring, by the intermediate computer, items purchased by the customer in the past purchases to determine the likelihood that the customer will desire to purchase respective items on their next order; calculating, by an intermediate computer, how many items on average in each category of products the customer purchases on each order; generating, by the intermediate computer, the recommended shopping list using the scoring of the items and the calculation of how many items on average in each category of products the customer purchases on each order; and transmitting from the intermediate computer to a customer device the recommended shopping list.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is an exemplary process flow diagram of the recommender system.

FIG. 2 is a flow chart of the recommender's logic.

FIG. 3 is an interaction flow diagram.

FIG. 4 shows a recommended item total calculation logic.

FIG. 5 shows a user interaction and design of the recommender system displayed on a smartphone.

FIG. 6 shows a user interaction and design of the recommender system displayed on a tablet computer

### DETAILED DESCRIPTION OF THE INVENTION

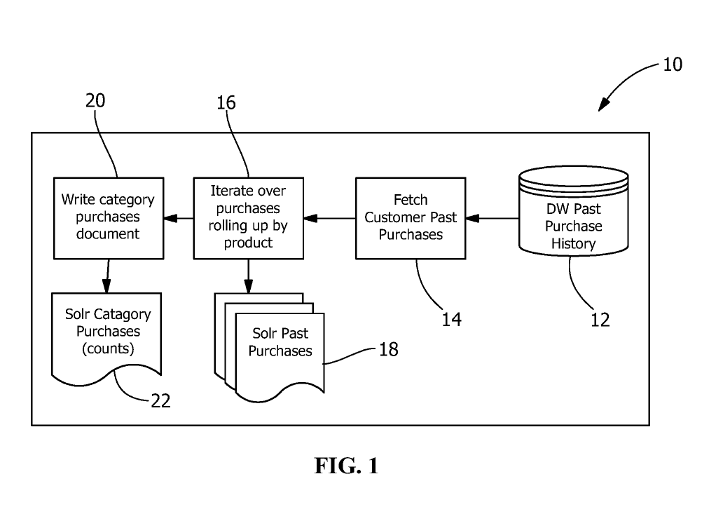

Referring to FIG. 1, a recommender search engine indexer process flow 10 is shown. The search engine may be used, e.g., SOLR, an open source enterprise search platform built on Apache Lucene™. The processor flow 10 includes a database 12 which stores a customer past purchase history on an intermediate computer. Next, step 14 of the process flow 10 fetches customer past purchases from the database 12. After fetching customer past purchases at step 14, process flow 10 proceeds to step 16 and iterates over purchases that are rolled up by product. The process flow 10 then proceeds to step 18 in which SOLR past purchases are generated in a document. After iterating over product purchases at step 16, process flow 10 proceeds to write a category purchases document. Process flow 10 then proceeds at step 22 to generate SOLR category purchase purchases by counts at step 22.

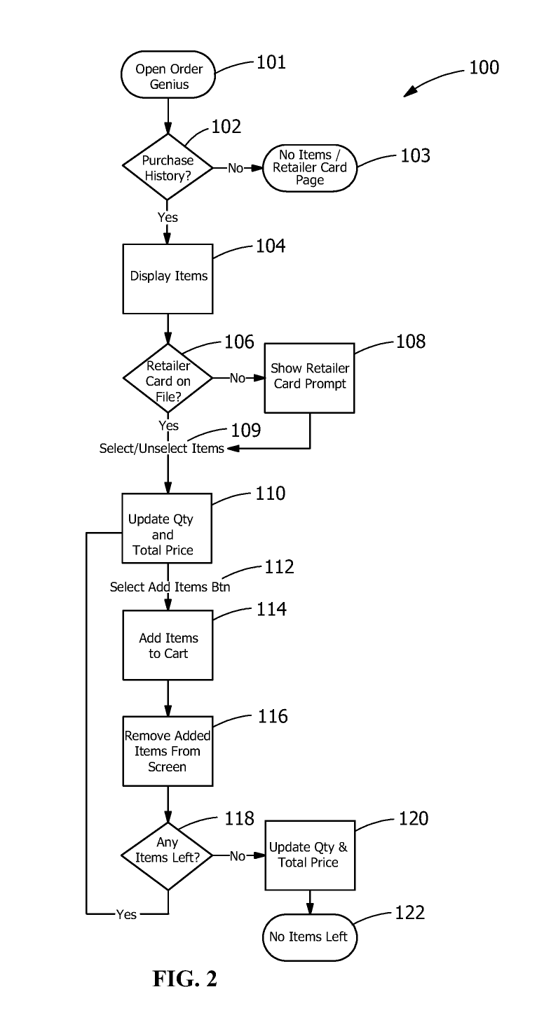

Referring next to FIG. 2, a flow chart of the recommender's logic is illustrated. At step 101, the recommender system 100 is opened by the user on a device containing the application. System 100 then proceeds to step 102 and determines whether a purchase history exists for the respective user. At step 102, if no purchase history exists, system 100 proceeds to step 103 and generates no items or retailer card page. If no purchase history is available, the retailer card collection page is presented, if the user has not entered it yet. This is the end of the logic flow for that path. If system 100 determines that a purchase history exists for the user, system 100 proceeds from step 102 to display a listing of items or products from the user's purchase history at step 104. System 100 then proceeds to step 106 and determines if a retailer card is on file for the respective user. If system 100 determines that no retailer card is on file, system 10 proceeds to step 108 and optionally generates a retailer card prompt. The retailer card prompt is there to promote the entry of a card by the user if they have one. This is the end of the logic.

System 100 then returns from step 108 to permit the user to select or unselect items or products for placement in a shopping cart at step 109. If at step 106 system 100 determines that a retailer card is on file for the user, then system proceeds to step 109 and provides an interface or display for the user to select and unselect items for placement in the shopping cart. Next, at step 110 the system 100 updates the quantity and total price of selected or unselected items. The user then proceeds from step 110 to select and add items with a selection element on the display, e.g., a button, at step 112 and adds selected items to the shopping cart at step 114. Once items have been added to the shopping cart, system 100 proceeds to step 116 to remove added items from the list of items displayed on the graphic user interface. After removing items at step 116, system 100 proceeds to step 118 and determines if any items for remaining. If no, system 100 proceeds to step 120 to update purchased item or product quantities and generate the total price of the items in the shopping cart. If at step 118 system 100 determines that there are items remaining on the display, system 100 returns to step 110 to update the quantity and total price of items in the shopping cart, and repeats steps 112 through 118. Returning to step 120, once the quantity and total price of items in the shopping cart are updated, system 100 ends the logic flow with a message at step 122 to the user that there are no items left in the cart.

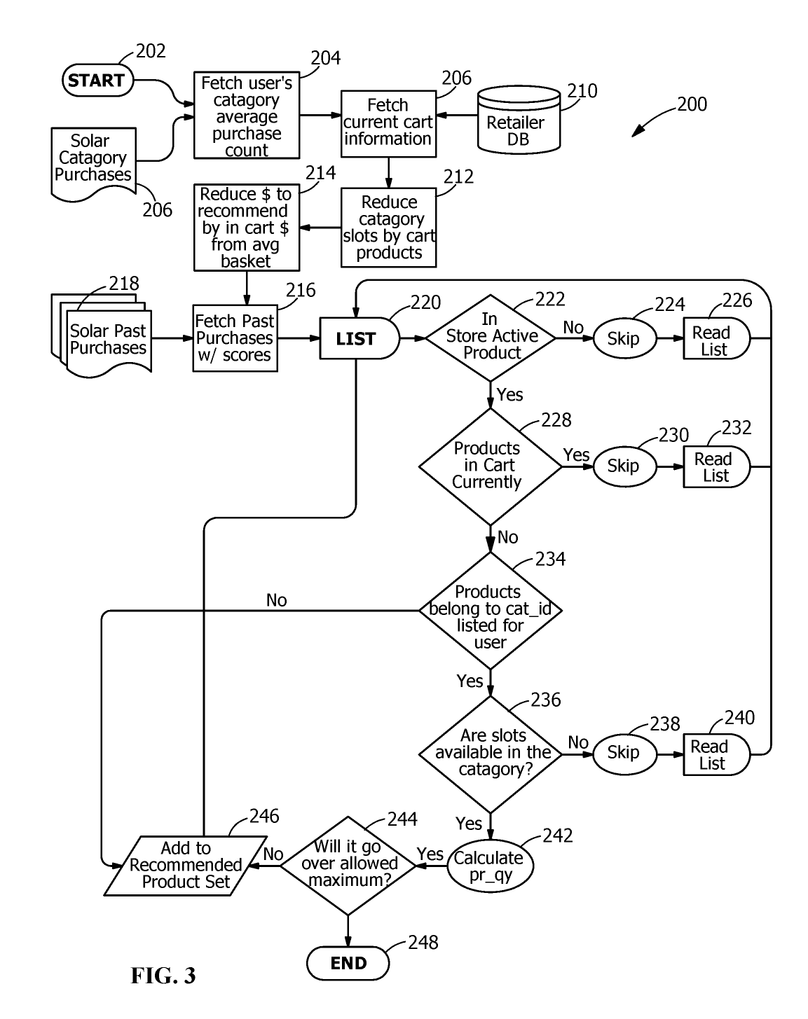

Referring next to FIG. 3, an interaction flow 200 is described. At step 202 the user initializes the system 100 with a start button. System 100 fetches a user's category average purchase counts at step 204 from SOLR category purchase document 206. System 100 proceeds to at step 208 to fetch card information from real retailer database 210. From step 208, system 100 proceeds to step 212 to reduce category slots by cart products. Next at step 214 system 100 reduces the dollars to recommend by in-cart dollars from the average basket amount. Next at step 216, system 100 fetches past purchases with scores from SOLR past purchases document 218. System 100 then proceeds to step 220 to compile a list. At step 220, system 100 also receives input from read list steps 226, 232 and 240, and from step 246, to add recommended products set, as described below. System 100 proceeds from step 220 to determine at step 222 if the listed item is an in-store active product. If no, system 100 proceeds to step 224, and skips the listed items and proceeds into step 226 to read the list and return to step 220. If at step 222 system 100 determines that the listed item or product is an active product, system 100 proceeds to step 228 to determine if a listed item or items of products is in the cart currently. If yes, then system 100 proceeds to step 230 and skips the listed items then proceeds to step 232 to read the list and return to step 220. If at step 228, system 100 determines that the product is not in the cart currently, system 100 proceeds to step 234 to determine if any of the listed products belong to a category ID listed for the user. If not, system 100 proceeds to step 246 to add the rectum and add the listed items to the recommended products set and returns to step 220 to update the list. If however, at step 234 system 100 determines that the product list of product belongs to the category ID listed for the user, system 100 proceeds to step 236 to determine if slots are available in the respective category. If no, system 100 proceeds to step 238 and skips the listed items, and then to step 240 to read the list. System 100 returns from step 240 to step 220 to update the list. If however on step 236 system 100 determines that slots are available in the category, system 100 proceeds to calculate price and quantity at step 242. Next, system 100 determines at step 244 if adding the listed items to the shopping cart will exceed the maximum. If no, system 100 proceeds to step 246 to add items to the recommended product set, and returns to step 220 to resume the process flow. If at step 244, system 100 determines that the listed items will exceed the maximum, the process flow proceeds to step 248 to end the logic flow.

In an alternative embodiment, at step 202 the user initializes the system 100 with a start button. System 100 fetches a user's category average purchase counts at step 204 from SOLR category purchase document 206. System 100 proceeds to at step 208 to fetch card information from real retailer database 210. Next at step 214 system 100 reduces the dollars to recommend by in-cart dollars from the average basket amount. Next at step 216, system 100 fetches past purchases with scores from SOLR past purchases document 218. System 100 then proceeds to step 220 to compile a list. At step 220, system 100 also receives input from read list steps 226 and 232, and from step 246, to add recommended products set, as described below. System 100 proceeds from step 220 to determine at step 222 if the listed item is an in-store active product. If no, system 100 proceeds to step 224, and skips the listed items and proceeds into step 226 to read the list and return to step 220. If at step 222 system 100 determines that the listed item is an active product, system 100 proceeds to step 228 to determine if a listed item or items of products is in the cart currently. If yes, then system 100 proceeds to step 230 and skips the listed items then proceeds to step 232 to read the list and return to step 220. If at step 228, system 100 determines that the product is not in the cart currently, system 100 proceeds to calculate price and quantity at step 242. Next, system 100 determines at step 244 if adding the listed items to the shopping cart will exceed the maximum. If no, system 100 proceeds to step 246 to add items to the recommended product set, and returns to step 220 to resume the process flow. If at step 244, system 100 determines that the listed items will exceed the maximum, the process flow proceeds to step 248 to end the logic flow.

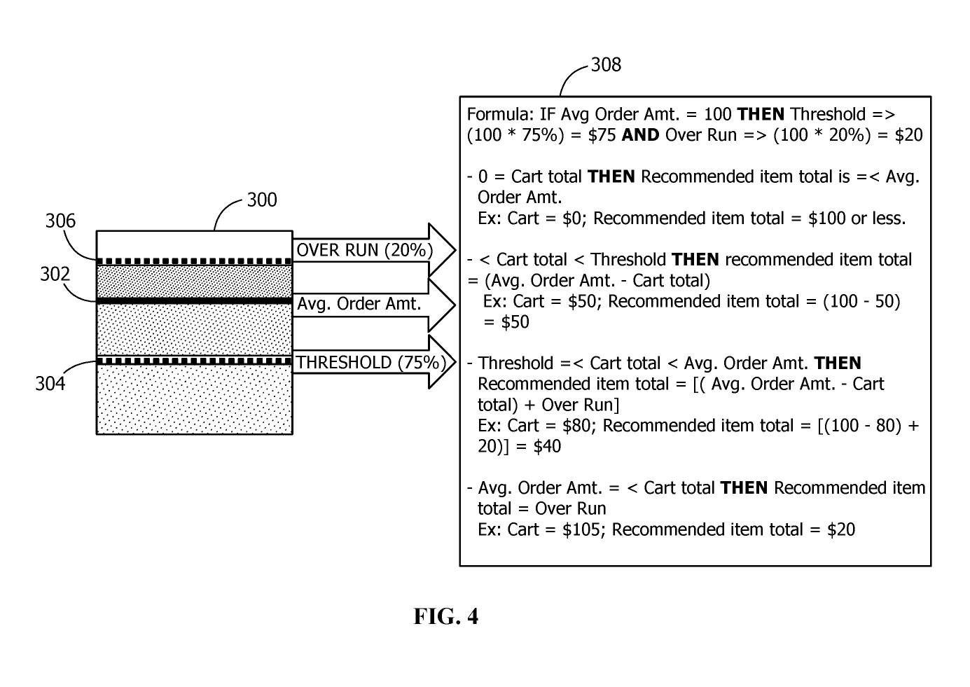

FIG. 4 shows a recommended item or product total calculation logic for the recommender system 100. A bar graph 300 indicates various threshold amounts for the recommender system in responding to a shopping cart total amount. An average order amount 302 represents the amount of an average order for the respective user. A below average threshold 304, for example, 75% of the average order amount, is established. Also an overrun threshold 306 is indicated on the bar graph. The overrun threshold establishes an amount by which a shopping cart total may exceed the average order amount 302.

A box 308 contains an algorithm for determining the action to be taken by recommender system based on the thresholds established for 75% order amount, average order amount, and overrun order amount. The formulas are set forth below:

IF:

Average order amount=100 THEN Threshold=>(100*75%)=$75 AND Overrun=>(100*20%)=$20;

0=Cart total THEN Recommended Item total Is=<Avg. Order Amount;

Ex: Cart=$0; Recommended Item total=$100 or less;

0<Cart total<Threshold THEN Recommended Item total=(Avg. Order Amount.−Cart total);

Ex: Cart=$50; Recommended Item total=(100−50)=$50;

Threshold=<Cart total<Avg. Order Amount. THEN Recommended Item total: [(Avg. Order Amt.−Cart total)+Over Run);

Ex: Cart=$80; Recommended Item total=[(100−80)+20]=$40;

Avg. Order Amount.=<Cart total THEN Recommended Item total=Over Run;

Ex: Cart=$105; Recommended Item total=$20;

Recommender System Scoring Algorithm

The recommender system 100 includes a scoring algorithm to score products for the shopping cart. Parameters are used to generate a score for each product that a user has ordered. The following parameters and derived parameters may be used for each user in the set of all users:

Given the following parameters:

U: The set of all users that we have past purchases data for within the past two years;

u: A single user, u ∈ U;

Pᵤ: The set of all products that exist in the past purchases data for a given user in the past two years;

pᵤ: A single product that was ordered by a user, pᵤ ∈ Pᵤ;

tₚᵤ: The total number of times a unique product was ordered in the past two years for a given user;

oₚᵤ: The days since last order of a product for a given user;

fₚᵤ: The average frequency at which a product was ordered in days for a given user.

The following derived parameters:

tₚᵤₘₐₓ=maxpu ∈ Pᵤ {tₚᵤ}: The maximum number of times a single product was ordered in the past two years of all products, Pᵤ;

oₚᵤₘₐₓ=maxₚᵤ ∈ Pᵤ {oₚᵤ}: The maximum number of days since a product was last ordered of all products.

Based on the defined parameters and derived parameters, as scoring formula may be applied. For a given user, u the system determines a score for each product, pᵤ ∈ Pᵤ such that the likelihood of that product to be in their next order based on previous order history can be determined. To determine this probability the system first calculates a base probability, P(Order), of the user wanting to order a given product using the days since last order and the order frequency.

$$P ( Order ) = min \{ \frac{{o}_{pu}}{{f}_{pu}} , \frac{{f}_{pu}}{{o}_{pu}} \}$$

Application of the min function constrains the ratio between 0 and 1. The probability alone is not sufficient to calculate the likelihood of a user ordering a product. Therefore, two confidence multipliers are established to make this probability more reliable.

CMₒₚ: CMₒₚ is a multiplier that determines for a given product how confident the system is based on the days since last order. In one example, if a user has ordered two products where one was ordered twenty days ago and the other was ordered two days ago. The multiplier CMₒₚ scales down the likelihood of the product ordered twenty days ago. CMₒₚ helps to reduce the suggestions of products that the user does not order anymore.

$${CM}_{op} = \frac{{max}_{p ∈ P} \{ {o}_{p} \} - {o}_{p}}{{max}_{p ∈ P} \{ {o}_{p} \}}$$

CMₜₚ: CMₜₚ determines for a given product how confident the system is based on the number of times a product was ordered by the user in the past. CMₜₚ scales down the likelihood of a product being ordered dependent on how many of the orders in the past two years included the respective product.

$${CM}_{tp} = \frac{{t}_{p}}{{max}_{p ∈ P} \{ {t}_{p} \}}$$

The system obtains a resultant score Sₚᵤ by multiplying the values together as shown in the equation below:

Sₚ_{ᵤ}=CMₒ_{ₚ}−CMₜ_{ₚ}·P(Order)

By expanding the terms the system determines Sₚᵤ as set forth below:

$${S}_{pu} = \frac{{max}_{p ∈ P} \{ {o}_{p} \} - {o}_{p}}{{max}_{p ∈ P} \{ {o}_{p} \}} \cdot \frac{{t}_{p}}{{max}_{p ∈ P} \{ {t}_{p} \}} \cdot min \{ \frac{{o}_{p}}{{f}_{p}} , \frac{{f}_{p}}{{o}_{p}} \}$$

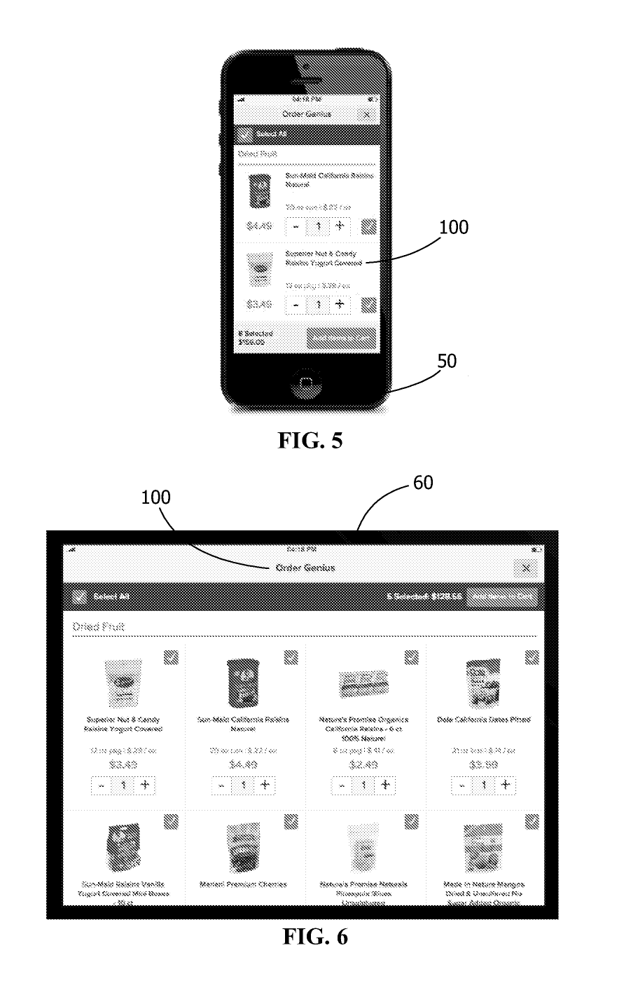

FIG. 5 shows the recommender system displayed on a smartphone, e.g., an iPhone 50.

FIG. 6 shows a user interaction and design of the recommender system displayed on a tablet computer

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A computer implemented method for generating a recommended list of items for a customer to purchase, the method comprising:
analyzing, by an intermediate computer, the customers past purchases;
scoring, by the intermediate computer, items purchased by the customer in the past purchases to determine the likelihood that the customer will desire to purchase respective items on their next order;
generating, by the intermediate computer, the recommended list of items for a customer to purchase based on the scoring of the items;
transmitting from the intermediate computer to a customer device the recommended list of items for a customer to purchase.

2. The method of claim 1, wherein the scoring system uses the number of times the customer has previously ordered an item to score the item.

3. The method of claim 1, wherein the scoring system uses the frequency of times the customer has previously ordered an item to score the item.

4. The method of claim 1, wherein the scoring system uses the number of days since the customer has last order the item to score the item.

5. The method of claim 1, further comprising categorizing, by the intermediate computer, the items into designated categories of products.

6. The method of claim 5, further comprising calculating, by an intermediate computer, how many items on average in each category of products the customer purchases on each order.

7. The method of claim 6, further comprising recommending, by an intermediate computer, no more items in each category of products than the average number of items in each category of products the customer purchases on each order.

8. The method of claim 1, further comprising adjusting, by the intermediate computer, for the amount of remaining budget dollars of the customer after items are moved to a cart, to reduce the number of items recommended in one or more categories of products.

9. The method of claim 8, wherein the number of items recommended in a category of products is calculated by subtracting the number of the items on average in the category of products the customer purchases on each order less the number of the items in the category of products provided in a cart.

10. The method of claim 1, wherein the recommended shopping list is the most likely set of items the customer will purchase based on a historical average quantity per item up to the limit of the recommended list of items for a customer to purchase.

11. The method of claim 1, further comprising calculating the historical average customer order size in dollars to establish a budget limit.

12. The method of claim 10, wherein a percentage of variance will be added to the budget limit to accommodate item recommendations within proximity of the budget limit.

13. The method of claim 1, wherein the recommended shopping list is presented in a single view, ordered by category of product, with a default quantity set for each item in the recommended list of items for a customer to purchase.

14. The method of claim 12, wherein each item may be selected or unselected individually.

15. The method of claim 12, wherein the recommended list of items for a customer to purchase includes a total dollar amount which is calculated and displayed to the customer to indicate the total dollar amount associated with the items selected in recommended list of items for a customer to purchase.

16. The method of claim 12, wherein a single Add to Cart options allows all selected items and associated quantity indications will be added to a shopping cart.

17. A computer implemented method for generating a recommended shopping list for a customer, the method comprising:
analyzing, by an intermediate computer, the customers past purchases;
scoring, by the intermediate computer, products purchased by the customer in the past purchases to determine the likelihood that the customer will desire to purchase respective products on their next order, the scoring using the number of times the customer has previously ordered the product, the frequency of times the customer has previously ordered and the number of days since the customer has last order the product to score the product;
generating, by the intermediate computer, the recommended shopping list based on the scoring of the products;
transmitting from the intermediate computer to a customer device the recommended shopping list.

18. A system for generating a recommended shopping list for a customer, the system comprising:
analyzing, by an intermediate computer, the customers past purchases;
scoring, by the intermediate computer, items purchased by the customer in the past purchases to determine the likelihood that the customer will desire to purchase respective items on their next order;
calculating the historical average customer order size in dollars to establish a budget limit;
generating, by the intermediate computer, the recommended shopping list based on the scoring of the items and the budget limit;
transmitting from the intermediate computer to a customer device the recommended shopping list.

19. The system of claim 1, further comprising adjusting, by the intermediate computer, for the amount of remaining budget dollars of the customer after items are moved to a cart, to reduce the number of items recommended in one or more categories of products.

20. A system for generating a recommended shopping list for a customer, the system comprising:
analyzing, by an intermediate computer, the customers past purchases;
scoring, by the intermediate computer, items purchased by the customer in the past purchases to determine the likelihood that the customer will desire to purchase respective items on their next order;
calculating, by an intermediate computer, how many items on average in each category of products the customer purchases on each order;
generating, by the intermediate computer, the recommended shopping list using the scoring of the items and the calculation of how many items on average in each category of products the customer purchases on each order;
transmitting from the intermediate computer to a customer device the recommended shopping list.
